(19) United States
(12) Patent Application Publication
(10) Pub. No.: US 2023/0279909 A1
(43) Pub. Date: Sep. 7, 2023

(54) FREEWHEEL ARRANGEMENT AND DRIVETRAIN FOR A MOTOR VEHICLE HAVING SUCH A FREEWHEEL ARRANGEMENT

(71) Applicant: BorgWarner Inc., Auburn Hills, MI (US)

(72) Inventors: Friedrich Philipp Brezger, Karlsruhe (DE); Oliver Groneberg, St. Leon-Rot (DE); Calahan B. Campton, Royal Oak, MI (US); Steven J. Kowal, Naperville, IL (US)

(21) Appl. No.: 18/116,555

(22) Filed: Mar. 2, 2023

(30) Foreign Application Priority Data
Mar. 2, 2022 (DE) 102022000740.1

(51) Int. Cl. F16D 41/16; B60K 17/356; B60K 17/354

(52) U.S. Cl. CPC F16D 41/16; B60K 17/356; B60K 17/354

(57) ABSTRACT

The present invention relates to a freewheel arrangement (4) having a freewheel (2), which comprises a first running ring (44), a second running ring (46), at least one clamping element (26; 28) that is between the first and the second running ring (44, 46) and is movable between a coupling position and a release position, and an actuating element (42) for adjusting the at least one clamping element (26; 28), wherein the actuating element (42) can be arranged on the first running ring (44) and is movable relative to the first running ring (44). A friction device (52) for generating a frictional force acting on the actuating element (42) is provided, the frictional force counteracting a drive force acting on the first running ring (44) so as to move the actuating element (42) relative to the first running ring (44). The present invention furthermore relates to a drivetrain (82) having such a freewheel arrangement (4).

### CROSS-REFERENCE TO RELATED APPLICATIONS

This application claims priority pursuant to 35 U.S.C. 119(a) to German Patent Application No. 102022000740.1 filed Mar. 2, 2022, which application is incorporated herein by reference in its entirety.

### BACKGROUND

The present invention relates to a freewheel arrangement having a freewheel, which comprises a first running ring, a second running ring, at least one clamping element that is between the first and the second running ring and is movable between a coupling position and a release position, and an actuating element for adjusting the at least one clamping element, wherein the actuating element can be arranged on the first running ring and can be moved relative to the first running ring. The present invention furthermore relates to a drivetrain for a motor vehicle, having such a freewheel arrangement.

DE 10 2021 002 531 A1 describes a freewheel having a first running ring, a second running ring, and multiple clamping elements between the first and the second running ring. The clamping elements, which are in the form of ratchets, can be moved or pivoted between a release position, in which the first running ring can be rotated relative to the second running ring in a first rotational direction, and a coupling position, in which the first running ring is rotationally conjointly coupled to the second running ring via at least one of the clamping elements in the rotational direction mentioned. In order to be able to selectively control or actuate the known freewheel, it also comprises an actuating element which is arranged on the first running ring, is movable relative to the first running ring, and by means of which the clamping elements can be adjusted. For instance, in the case of the known freewheel, the actuating element has an annular form and is rotatable relative to the first running ring, in order to be able to transfer the clamping elements into the release position or coupling position. An actuating device, using which the actuating element can be moved relative to the first running ring in order to adjust the clamping elements, is not disclosed. However, drive devices which generate a corresponding movement force and transmit it to the actuating element via a mechanism acting between the drive device and the actuating element, are known from practice. Such a drive device and mechanism with corresponding actuators and the associated open-loop control need additional installation space, make the freewheel more susceptible to faults, and require complex open-loop control.

### SUMMARY

An object of the present invention is therefore to refine a freewheel arrangement of the type in question in such a way that it has a simple and space-saving structure and ensures simple and reliable open-loop control. Furthermore, the present invention is based on the object of providing a drivetrain for a motor vehicle having an advantageous freewheel arrangement of this type.

Said object is achieved by the features specified in patent claims 1 and 10. The dependent claims relate to advantageous embodiments of the invention.

The freewheel arrangement according to the invention is used preferably in the drivetrain of a motor vehicle and has a freewheel. The freewheel has a first running ring, that is to say for example an outer ring or inner ring, a second running ring, that is to say for example an inner ring or outer ring, and at least one clamping element arranged between the first and the second running ring. The clamping elements are preferably pivotable ratchets, with the result that, in the case of such an embodiment variant, reference can also be made to a ratchet freewheel of the freewheel arrangement. The clamping elements can be moved or pivoted between a coupling position and a release position. For instance, in a coupling position, at least one clamping element is used to obtain coupling between the first and the second running ring in at least one direction of relative rotation, while in the release position a relative rotation in the direction of relative rotation mentioned is enabled. In order to be able to selectively transfer or adjust the at least one clamping element into the respective position, an actuating element for adjusting the at least one clamping element is provided. The actuating element, which is preferably in the form of an actuating ring, is arranged on the first running ring of the freewheel and can be moved, preferably rotated, relative to the first running ring. In this respect, it is preferred if the actuating element is movable or rotatable only within a limited range relative to the first running ring. In order to achieve simple, reliable and space-saving open-loop control of the actuating element and therefore of the clamping elements, a friction device for generating a frictional force acting on the actuating element is provided, wherein the frictional force counteracts a drive force acting on the first running ring so as to move the actuating element relative to the first running ring, with the result that the movement of the actuating element relative to the first running ring makes corresponding adjustment of the at least one clamping element possible. In the case of an actuating element that is rotatable relative to the first running ring, it is preferred when the friction device serves to generate a frictional moment, which acts on the actuating element and results from the frictional force, the frictional moment counteracting a drive torque, which acts on the first running ring and results from the drive force, so as to move or rotate the actuating element relative to the first running ring. In any case, for the freewheel arrangement according to the invention, the friction device makes it possible to obtain a particularly straightforward and reliable structure which brings about correspondingly straightforward and reliable open-loop control of the actuating element and therefore of the at least one clamping element.

In a preferred embodiment of the freewheel arrangement according to the invention, the friction device is designed in such a way that the frictional force or the frictional moment can be or is automatically reduced by increasing the rotational speed of the first running ring. It would thus be possible in the case of this embodiment to design the friction device, for example, in the manner of a centrifugal clutch. This embodiment provides a freewheel arrangement which is easy and reliable to influence or/and control without external engagement depending on the rotational speed of the first running ring.

In a further preferred embodiment of the freewheel arrangement according to the invention, the friction device is designed in such a way that the frictional force or the frictional moment can be or is automatically reduced under the action of centrifugal force by increasing the rotational speed of the first running ring, in order analogously to form the centrifugal clutch already specified above.

According to an advantageous embodiment of the freewheel arrangement according to the invention, the friction device is designed in such a way that, above a predetermined rotational speed of the first running ring, the frictional force or the frictional moment is not only reduced but is completely eliminated, with the result that the frictional force or the frictional moment no longer counteracts the movement or rotation of the actuating element and thus also of the first running ring.

In a further advantageous embodiment of the freewheel arrangement according to the invention, the friction device comprises at least one friction part on the actuating element side and at least one friction part on the component side that can be brought, or is brought, into frictional engagement with the friction part on the actuating element side to obtain the frictional force or the frictional moment. The friction part on the actuating element side can be rotationally conjointly coupled to the actuating element as separate friction part or be formed in one piece with the actuating element. The friction part on the component side can likewise be rotationally conjointly coupled to a further component of the freewheel arrangement as separate friction part or be formed in one piece with such a further component of the freewheel arrangement. The further component can in principle be any component of the freewheel arrangement that performs a relative rotation with respect to the first running ring and therefore also the actuating element, in order, in frictional engagement, to generate the frictional force or frictional moment counteracting the drive force or the drive torque. However, it has been found to be particularly advantageous when the further component is a stationary component of the freewheel arrangement, in order to be able to predefine the operating behavior of the freewheel arrangement particularly reliably. It has thus been found to be particularly advantageous when the further component is not only stationary, but is in the form of a stationary housing of the freewheel arrangement, in order to make use of a component of the freewheel arrangement or of the drivetrain that is present in any case, to realize the friction device in a space-saving manner.

In a further preferred embodiment of the freewheel arrangement according to the invention, the friction part on the actuating element side is pretensioned against the friction part on the component side in a first axial direction by a spring element. In the case of this embodiment, in order to obtain an even greater frictional force, it is further preferred if a second friction part on the actuating element side, which is pretensioned against a second friction part on the component side in a second axial direction counter to the first axial direction by the spring element, is provided. Although an additional spring element could be assigned to the second friction part on the actuating element side, the use of the same spring element for both friction parts on the actuating element side results in a particularly compact structure.

As already specified above, in an advantageous embodiment, the frictional force or the frictional moment of the friction device can be or is reduced preferably under the action of centrifugal force. Against this background, in a particularly preferred embodiment of the freewheel arrangement according to the invention, a spring force, which is applicable to the friction part on the actuating element side or the frictional parts on the actuating element side by the spring element mentioned above, can be or is reduced under the action of centrifugal force. In other words, the spring force applied by the spring element is reduced as the rotational speed of the first running ring increases and the centrifugal force acting on the spring element increases with it. In this context, what has been found to be advantageous in particular is a spring element which is designed in the manner of a ring which is elastically expansible under the action of centrifugal force and interacts with the friction part on the actuating element side or the friction parts on the actuating element side. Thus, the elastically expansible ring can, for example, be a ring which has an interruption in order to facilitate elastic expansion. Moreover, in the event of use of such an elastically expansible ring, it has been found to be advantageous when either the cross section of the ring or the friction part on the actuating element side that interacts with the ring to have an oblique contact surface, with the result that the radially inwardly acting spring force can be suitably deflected to the axial direction mentioned in order to pretension the respective friction part on the actuating element side against the friction part on the component side.

In a further preferred embodiment of the freewheel arrangement according to the invention, the at least one friction part on the actuating element side is an axial finger, wherein preferably multiple circumferentially spaced-apart friction parts on the actuating element side that are in the form of such an axial finger are provided. The axial finger is pretensioned radially inward against the friction part on the component side, the pretension being brought about owing to the elasticity of the axial finger and not, however, by an additional spring element, as a result of which the structure of the freewheel arrangement is considerably simplified. The axial finger is dimensioned or designed in such a way that it can be elastically bent outward in a radial direction under the action of centrifugal force with a reduction in a pretensioning force acting on the friction part on the component side, in order to reduce the frictional force or the frictional moment of the friction device. As already specified above, the omission of a separate spring element makes it possible to obtain a particularly straightforward and reliable structure.

In the case of the embodiment already described with the axial fingers, in order to obtain a particularly robust and durable structure, in a further advantageous embodiment of such a freewheel arrangement, provision is also made of a support element, against which the radially outwardly bent axial finger (60) is supportable outwardly in a radial direction, in order to reduce the loading on the axial finger and thus prevent it from breaking in any way. By virtue of the radially outward support of the bent axial finger, it is also ensured that it retains its elasticity to the greatest possible extent throughout the service life of the freewheel arrangement.

In a further advantageous embodiment of the freewheel arrangement according to the invention, the support element mentioned above for supporting the bent axial finger is rotationally conjointly coupled to the first running ring in order to keep a relative movement between the axial finger and the support element small, and thus to keep the wear low. Preferably, the rotationally conjoint coupling to the first running ring is done via a side wall of the freewheel.

According to a further advantageous embodiment of the freewheel arrangement according to the invention, the support element for supporting the radially outwardly bent axial finger has an annular form, in order to ensure particularly reliable and stable support of the bent axial finger.

In a further advantageous embodiment of the freewheel arrangement according to the invention, a side wall for covering a clamping gap that receives the at least one clamping element or/and for supporting the clamping element in an axial direction is arranged on or fastened to the first running ring. In order to obtain a particularly compact structure of the freewheel inside the freewheel arrangement, in this embodiment the actuating element is preferably arranged between the first running ring and the side wall in an axial direction.

According to a further, particularly preferred embodiment of the freewheel arrangement according to the invention, in which embodiment the friction part on the actuating element side is formed by an axial finger, the support element for supporting the bent axial finger outwardly in a radial direction is arranged on or fastened to the side wall, or is formed in one piece with this side wall. In the latter case, the support element can, for example, be formed in one piece with the side wall in the form of a shaped sheet-metal part. In order to obtain a particularly compact and space-saving structure here in turn, the at least one axial finger particularly preferably extends through a recess in the side wall, in order to be arranged inside the support element with respect to the radial direction.

As already specified above, in a preferred embodiment of the freewheel arrangement according to the invention the actuating element is not just movable relative to the first running ring, but rather is rotatable relative to the first running ring. In this respect, it has been found to be advantageous when the first running ring is rotatable about an axis of rotation, while the actuating element is rotatable about precisely this axis of rotation relative to the first running ring. In this embodiment, it is also preferred when the actuating element is rotatable relative to the first running ring only in a limited angular range preferably amounting to at most 20°, in order to realize short actuating travels.

In order to enable a particularly straightforward arrangement and guidance of the actuating element on the first running ring, the actuating element preferably has an annular form, with in particular an annular disk-shaped form being advantageous, at least in one portion of the actuating element.

According to a further advantageous embodiment of the freewheel arrangement according to the invention, the actuating element is movable, preferably rotatable, between two end positions relative to the first running ring. In the two end positions, the actuating element is preferably supported on the first running ring in the respective direction of relative rotation via a stop. In this case, the stop can be fastened either to the actuating element or the first running ring and, for example, extend into a guide in the first running ring or in the actuating element. In this context, what has been found to be advantageous is a stop which is fastened to the first running ring or formed in one piece therewith and extends into a guide or opening in the actuating element.

In a particularly advantageous embodiment of the freewheel arrangement according to the invention, at least one first clamping element and at least one second clamping element are provided. The at least one first clamping element and the at least one second clamping element are rotationally conjointly connected to the first or the second running ring. The first clamping element is pivotable between the release position, in which the first or the second running ring is rotatable relative to the other running ring, that is to say the second or the first running ring, in a first rotational direction, and the coupling position, in which the first or the second running ring is rotationally conjointly coupled to the other running ring, that is to say to the second or the first running ring, via the first clamping element in the first rotational direction. By contrast, the second clamping element is pivotable between the release position, in which the first or the second running ring is rotatable relative to the other running ring, that is to say the second or the first running ring, in a second rotational direction counter to the first rotational direction, and the coupling position, in which the first or the second running ring is rotationally conjointly coupled to the other running ring, that is to say to the second or the first running ring, via the second clamping element in the second rotational direction. This embodiment therefore relates to a freewheel inside the freewheel arrangement which enables both coupling in the one direction of relative rotation and coupling in the opposite direction of relative rotation between the two running rings, possibly even at the same time.

In a further advantageous embodiment of the freewheel arrangement according to the invention, in which embodiment the actuating element is movable into the two end positions mentioned above, the first and the second clamping element assume predetermined positions depending on the positions of the actuating element. In a first end position of the actuating element, the first clamping element assumes the release position and the second clamping element assumes the coupling position. In a second end position of the actuating element, which can also be referred to as the opposite end position to the first end position, the first clamping element assumes the coupling position, while the second clamping element assumes the release position. Furthermore, the actuating element can assume an intermediate position between the two end positions, in which intermediate position the actuating element interacts with the clamping elements in such a way that both the first clamping element and the second clamping element assume the release position.

In a further advantageous embodiment of the freewheel arrangement according to the invention, the first running ring, on which the actuating element is arranged, is in the form of an outer ring, on which also the at least one clamping element is arranged or optionally the first and second clamping elements are arranged.

According to a further advantageous embodiment of the freewheel arrangement according to the invention, the first running ring, on which the actuating element is arranged, is in the form of an inner ring, while the second running ring is in the form of an outer ring, on which the at least one clamping element is arranged or optionally the first and second clamping elements are arranged.

The drivetrain according to the invention for a motor vehicle has a first wheel axle and a second wheel axle. The first wheel axle can be driven by an electric drive unit, for example an electric machine, or/and a combustion engine. By contrast, the second wheel axle or/and a wheel on the second wheel axle is selectively drivable by an additional electric drive unit via a freewheel arrangement of the type according to the invention. By virtue of the use of the freewheel arrangement according to the invention, therefore, for example, a four-wheel drive or all-wheel drive is selectively realizable in a particularly reliable manner without excessive open-loop control outlay.

In a preferred embodiment of the drivetrain according to the invention, the first running ring of the freewheel arrangement is rotationally fixedly connected to the additional electric drive unit, while the second running ring of the freewheel arrangement is rotationally fixedly connected to the second wheel axis or to the wheel, it being possible to effect this indirectly or directly in each case.

### BRIEF DESCRIPTION OF THE DRAWINGS

The invention will be explained in more detail below on the basis of exemplary embodiments and with reference to the appended drawings, in which:

FIG. 1 shows a front view of a first embodiment of a freewheel for a freewheel arrangement;

FIG. 2 shows a partial side view, in a sectional illustration, of the freewheel from FIG. 1 inside a first embodiment variant of a freewheel arrangement;

FIG. 3 shows a partial side view, in a sectional illustration, of the freewheel from FIG. 1 inside a second embodiment variant of a freewheel arrangement;

FIG. 4 shows the detail A of FIG. 1 after the actuating element has been moved from the first end position to the second end position;

FIG. 5 shows a front view of a second embodiment of a freewheel for a freewheel arrangement;

FIG. 6 shows a partial side view, in a sectional illustration, of the freewheel from FIG. 5 inside a third embodiment variant of a freewheel arrangement;

FIG. 7 shows the detail B of FIG. 5 after the actuating element has been moved from the first end position to the second end position; and

FIG. 8 shows a schematic illustration of a drivetrain for a motor vehicle having a freewheel arrangement.

### DETAILED DESCRIPTION

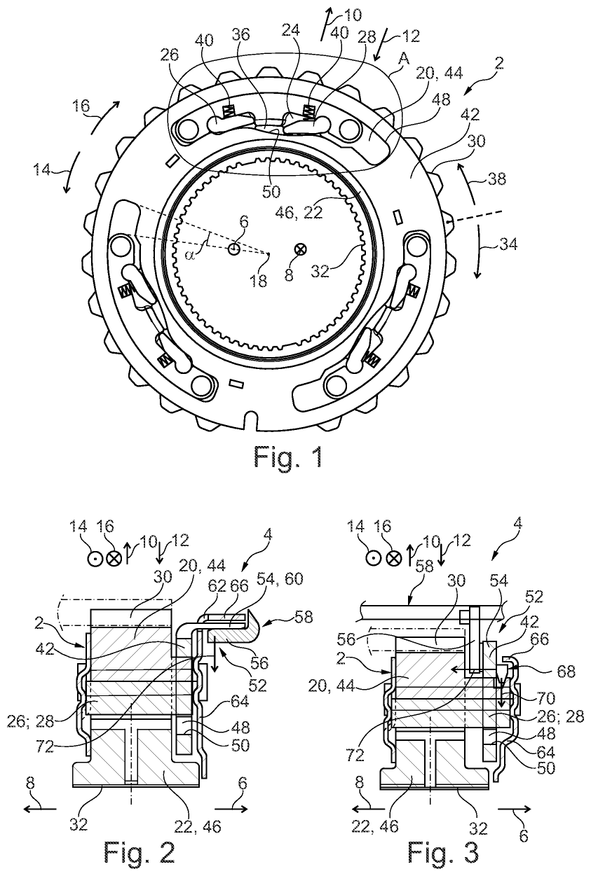

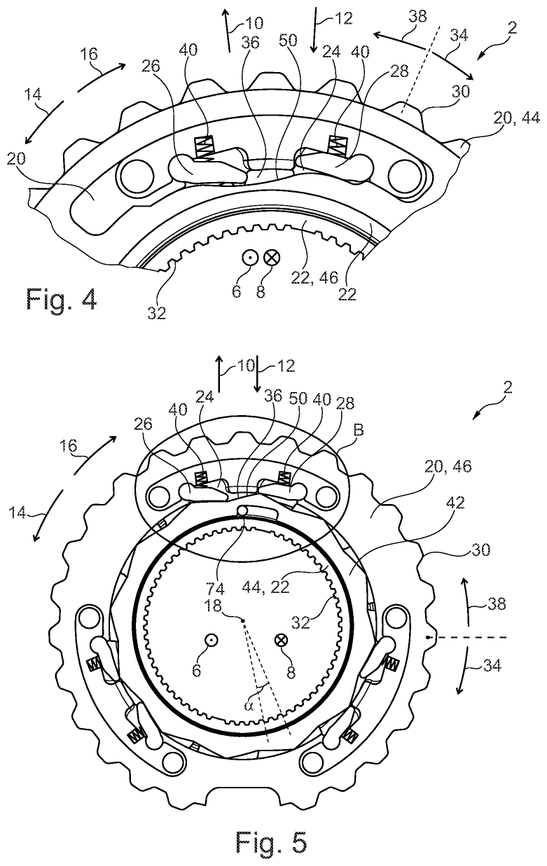

FIG. 1 shows a freewheel 2 for a freewheel arrangement 4 of a first embodiment variant according to FIG. 2 or a second embodiment variant according to FIG. 3, with FIG. 4 furthermore showing the detail A of FIG. 1 after the actuating element has been moved. In FIGS. 1 and 4, the side wall shown in FIGS. 2 and 3 has not been illustrated for reasons of clarity. In the figures, the mutually opposite axial directions 6, 8, the mutually opposite radial directions 10, 12 and the mutually opposite circumferential directions 14, 16 of the freewheel 2 of the freewheel arrangement 4 are indicated by way of corresponding arrows, the constituent parts of the freewheel 2 being rotatable in the circumferential directions 14, 16 about an axis of rotation 18 extending in the axial directions 6, 8.

The freewheel 2 has an outer ring 20, an inner ring 22, a clamping gap 24 in the radial direction 10, 12 that runs around in the circumferential direction 14, 16 between the outer ring 20 and the inner ring 22, and multiple clamping elements 26, 28 inside the clamping gap 24. Therefore, the outer ring 20, the inner ring 22 and the clamping elements 26, 28 are in a nested arrangement in the radial direction 10, 12. The outer ring 20 has a rotational drive contour 30, here in the form of a toothing, on its side facing outward in the radial direction 10. The inner ring 22 also has a rotational drive contour 32, which, however, is formed on that side of the inner ring 22, here likewise in the form of a toothing, that faces inward in the radial direction 12.

The clamping elements 26, 28 are in the form of pivotable ratchets, the clamping elements comprising first clamping elements 26 and second clamping elements 28. The clamping elements 26, 28 are arranged pivotably on the outer ring 20, with the result that they are rotatable together with the outer ring 20 in the circumferential directions 14, 16 about the axis of rotation 18, while the clamping elements 26, 28 themselves can be pivoted relative to the outer ring 20 between a coupling position and a release position. A respective first clamping element 26 and a respective second clamping element 28 form a clamping element pair, the clamping elements 26, 28 of a clamping element pair being at a smaller distance from one another in the circumferential direction 14, 16 than is the case for the clamping element pairs, which are spaced apart from one another uniformly in the circumferential direction 14, 16, as can be seen in particular in FIG. 1. In the embodiment illustrated, a total of three clamping element pairs are provided. The first clamping element 26 and the second clamping element 28 are pivotable in mutually opposite pivoting directions from a coupling position to a release position and vice versa, as will be explained below.

The first clamping element 26 is pivotable between the release position shown in FIG. 1, in which the outer ring 20 is rotatable in a first rotational direction 34 relative to the inner ring 22, and a coupling position shown in FIG. 4, in which the outer ring 20 is rotationally conjointly coupled to the inner ring 22 via the first clamping element 26 in the first rotational direction 34 mentioned. For the purposes of rotationally conjoint coupling, the first clamping element 26 engages in a toothing 36 on that side of the inner ring 22 that faces outward in the radial direction 10, as can be seen in FIG. 4. Correspondingly, but in the opposite pivoting direction, the second clamping elements 28 are pivotable between the release position shown in FIG. 4, in which the outer ring 20 is rotatable relative to the inner ring 22 in a second rotational direction 38 counter to the first rotational direction 34, and a coupling position shown in FIG. 1, in which the outer ring 20 is rotationally conjointly coupled to the inner ring 22 via at least one of the second clamping elements 28 in the second rotational direction 38, in that the second coupling element 28—as can be seen in FIG. 1—engages in the toothing 36 of the inner ring 22. It is also the case that both the first clamping elements 26 and the second clamping elements 28 are each pretensioned into the coupling position by a spring element 40, it advantageously being possible for the spring elements 40 to be formed by an accordion spring, although here in principle it is also possible to use simple helical springs or other spring elements.

In order to be able to pivot or adjust the clamping elements 26, 28, which are already pretensioned into the coupling position by the spring elements 40, between the two positions, specifically the coupling position and the release position, the freewheel 2 also has an actuating element 42 for adjusting the at least one clamping element 26, 28, the actuating element 42 serving to adjust both the first and the second clamping element 26, 28 of the freewheel 2. The actuating element 42 is arranged on one of the two running rings, that is to say the outer ring 20 or the inner ring 22, with the result that there is a rotationally conjoint connection between this running ring and the actuating element 42. In this case, here and in the following text, that running ring on which the actuating element 42 is arranged is referred to as first running ring 44, while the other running ring of the freewheel 2 is referred to as second running ring 46. In the embodiment according to FIGS. 1 to 4, the outer ring 20, on which the clamping elements 26, 28 are pivotably arranged, thus forms the first running ring 44 on which the actuating element 42 is arranged, while the inner ring 22 forms the second running ring 46.

Irrespective of the rotationally conjoint connection existing between the first running ring 44 and the actuating element 42, the actuating element 42 is, however, movable relative to the first running ring 44. More specifically, the annular, or substantially annular disk-shaped, actuating element 42 is rotatable relative to the first running ring 44 within a limited angular range α. This limited angular range α is preferably at most 20°. Therefore, the actuating element 42 is movable or rotatable in the circumferential directions 14, 16 relative to the first running ring 44 between a first end position shown in FIG. 1 and a second end position shown in FIG. 4, the actuating element 42 preferably being supported on the first running ring 44 via a stop, not illustrated in more detail, in the end positions.

In the embodiments according to FIGS. 1 to 4, the actuating element 42 substantially has an annular disk-shaped form, the clamping element pairs mentioned above of a respective first and second clamping element 26, 28 each being assigned a recess 48, which is continuous in the axial direction 6, 8 and in which the clamping elements 26, 28 extend in the axial direction 6, in the annular disk-shaped actuating element 42, with the result that the clamping elements 26, 28 are supportable inwardly in the radial direction 12 on an actuating contour 50, formed by that edge of the recess 48 that points outward in the radial direction 10, of the actuating element 42. By virtue of the actuating contour 50, the clamping element 26, 28 can assume the positions mentioned depending on the rotational position of the actuating element 42 relative to the first running ring 44. In the embodiment illustrated, the first clamping element 26 assumes the release position and the second clamping element 28 assumes the coupling position when the actuating element 42 is in the first end position shown in FIG. 1. In the second end position of the actuating element 42 shown in FIG. 4, by contrast, the first clamping element 26 assumes the coupling position, while the second clamping element 28 assumes the release position. Although not illustrated in an additional figure, the actuating contour 50 is thus formed on the actuating element 42 in such a way that both the first clamping element 26 and the second clamping element 28 assume the release position when the actuating element 42 has been rotated relative to the first running ring 44 into an intermediate position between the two end positions according to FIGS. 1 and 4.

Whereas FIGS. 1 and 4 illustrate substantially the constituent parts of the freewheel 2 of the freewheel arrangement 4, FIGS. 2 and 3, each of which shows an alternative configuration of the freewheel arrangement 4, additionally show a friction device 52, assigned to the freewheel 2, of the freewheel arrangement 4. The friction device 52 is designed in such a way that a frictional force acting on the actuating element 42 is generatable, the frictional force counteracting a drive force acting on the first running ring 44 so as to move the actuating element 42 relative to the first running ring 44. If the first running ring 44 in the form of the outer ring 20 is, for example, driven by a drive force acting on the first running ring 44 or by a corresponding drive torque in the first rotational direction 34, a frictional force of the friction device 52 acting in the second rotational direction 38, or a corresponding frictional moment, is brought about in the second rotational direction 38 mentioned, with the result that the annular actuating element 42 is rotated relative to the first running ring 44 from the first end position shown in FIG. 1 to the second end position shown in FIG. 4.

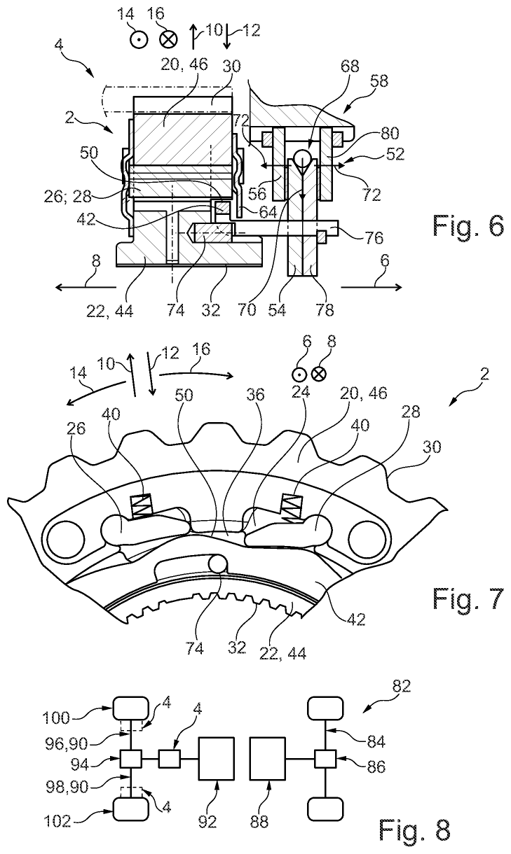

The friction device 52 has at least one friction part 54 on the actuating element side and at least one friction part 56 on the component side which can be brought, or is brought, into frictional engagement with the friction part 54 on the actuating element side so as to generate the frictional force mentioned. The at least one friction part 54 on the actuating element side can be rotationally conjointly coupled to the actuating element 42 as separate friction part, as will be described later on with reference to the embodiment variant of FIG. 6, or can be formed in one piece with the actuating element 42, as is the case in the two embodiment variants of FIGS. 2 and 3. The same applies to the friction part 56 on the component side, which can be fastened to a further component of the freewheel arrangement 4 as separate friction part, as is the case in the embodiment variant of FIGS. 3 and 6, while the friction part 56 on the component side can similarly be formed in one piece with the further component of the freewheel arrangement 4, as indicated in the embodiment variant of FIG. 2.

The further component of the freewheel arrangement 4 is indicated in the figures by the reference sign 58, the further component 58 preferably being a stationary component 58 which, by contrast to the constituent parts of the freewheel 2, is not rotated about the axis of rotation 18, the further component 58 particularly preferably being a stationary housing of the freewheel arrangement 4 or a drivetrain having such a freewheel arrangement 4.

In the embodiment variant of FIG. 2, the friction part 54 on the actuating element side is formed by an axial finger or an axial tongue 60, the axial finger 60 extending in the axial direction 6 from that end of the substantially annular disk-shaped actuating element 42 that points outward in the radial direction 10. Multiple axial fingers 60 are provided spaced apart from one another in the circumferential direction 14, 16 on the actuating element 42. The axial fingers 60 mentioned extend in the axial direction 6 through a respective recess 62 in a substantially annular disk-shaped side wall 64 of the freewheel 2. The annular disk-shaped side wall 64, which runs around in the circumferential direction 14, 16, is fastened to the first running ring 44 and serves to at least partially cover the clamping gap 24 and to support the clamping elements 26, 28 in the axial direction 6. As can be seen in FIG. 2, here the actuating element 42 or its annular disk-shaped portion is arranged between the first running ring 44 and the side wall 64 in the axial direction 6, 8.

The axial fingers 60, which project through the recesses 62 in the side wall 64 in the axial direction 6, are pretensioned inward in the radial direction 12 against the friction part 56 on the component side, the friction part 56 on the component side having a form which runs around in the circumferential direction 14, 16. Therefore, the pretensioning of the axial fingers 60 against the friction part 56 on the component side generates the frictional force mentioned above when the first running ring 44 together with the actuating element 42 is to be driven in one of the two rotational directions 34, 38. In this case, the axial fingers 60 have an elastic form such that, given a corresponding rotational speed of the first running ring 44 or of the actuating element 42, they can be elastically bent outward in the radial direction 10 under the action of centrifugal force with a reduction in the pretentioning force acting on the friction part 56 on the component side. In order to prevent the axial fingers 60 being subjected to excessive load and possibly being damaged in the event of high rotational speeds here, what is also provided is a support element 66, against which the axial fingers 60 bent outward in the radial direction 10 are supportable. In the embodiment variant of FIG. 2, the support element 66 is not only rotationally conjointly coupled to the first running ring 44 via the side wall 64, but also has a form running annularly around in the circumferential direction 14, 16. Moreover, the support element 66 in the embodiment illustrated is arranged on the side wall 64 described above and is formed in one piece with it.

It is clear from the above description of the embodiment variant of FIG. 2 that the friction device 52 is designed in such a way that the frictional force is automatically reduced, here under the action of centrifugal force, by increasing the rotational speed of the first running ring 44, this being effected by bending the axial fingers 60 outward in the radial direction 10 in the embodiment variant of FIG. 2. Although not illustrated, the friction device 52 is preferably configured in such a way that the frictional force is not just reduced but completely eliminated when a predetermined rotational speed of the first running ring 44 is reached. In the specific case of FIG. 2, this would mean that the axial fingers 60 are bent outward in the radial direction 10 under the action of centrifugal force far enough that they are no longer in contact with the friction part 56 on the component side. These statements correspondingly also apply to the friction devices 52 described in more detail below, in the case of which the frictional force is likewise reduced and possibly completely eliminated automatically, or under the action of centrifugal force, by increasing the rotational speed of the first running ring 44.

In the second embodiment variant of FIG. 3, the friction part 54 on the actuating element side is likewise formed in one piece with the actuating element 42, more specifically formed directly by an annular disk-shaped portion thereof. In this way, the friction part 54 on the actuating element side can be pretensioned against the friction part 56 on the component side in the axial direction 8, the friction part 56 on the component side being formed in the manner of an annular disk-shaped friction plate, which in turn is secured in the axial direction 8 to the further component 58 in the form of the stationary housing. The friction part 56 on the component side is arranged between the actuating element 42, or the friction part 54 on the actuating element side, on the one hand and the first running ring 44, on the other hand, in the axial direction 6, 8, the friction part 54 on the actuating element side, or the actuating element 42, being pretensioned against the friction part 56 on the component side in the axial direction 8 by means of a spring element 68. The spring element 68 is supported in the axial direction 6 on the first running ring 44 or the side wall 64 and in the axial direction 8 on the actuating element 42 or the friction part 54 on the actuating element side.

The spring force 70 applicable to the friction part 54 on the actuating element side by the spring element 68 is in turn reducible under the action of centrifugal force, in order to bring about a reduction in the frictional force generated by the friction device 52 given a correspondingly high rotational speed of the first running ring 44 in this embodiment variant too. To that end, in the second embodiment variant of FIG. 3, the spring element 68 is formed in the manner of a ring which is elastically expansible under the action of centrifugal force and interacts with the friction part 54 on the actuating element side. In this case, its spring force 70 acting inward in the radial direction 12 is converted into the pretensioning force 72 acting in the axial direction 8 via correspondingly slanted flanks on the cross section of the annular spring element 68.

FIGS. 5 to 7 show a further embodiment of the freewheel 2 for the freewheel arrangement 4, the structure substantially corresponding to the embodiment of FIGS. 1 to 4, the same reference signs being used for the same or similar parts, and the above description applying correspondingly in all other respects.

By contrast to the embodiment of FIGS. 1 to 4, the inner ring 22 in the embodiment of FIGS. 5 to 7 is in the form of the first running ring 44, on which the actuating element 42 is arranged in order to be able to rotate it relative to the first running ring 44 in the limited angular range α, whereas the second running ring 46 is formed by the outer ring 20, on which the clamping elements 26, 28 mentioned above are arranged. In the second embodiment, the actuating element 42 in turn is movable or rotatable relative to the first running ring 44 between two end positions, the stop 74 mentioned above, against which the actuating element 42 is supported in the respective end position, moreover being indicated in FIGS. 5 to 7.

Proceeding from that end of the actuating element 42 that points inward in the radial direction 12, holding fingers 76 extend in the axial direction 6, the friction element 54 on the actuating element side being rotationally fixedly arranged on the holding fingers 76. The friction part 54 on the actuating element side is formed in the manner of a friction plate. Furthermore, a second friction part 78 on the actuating element side is secured to the holding fingers 76, likewise is formed in the manner of a friction plate, and is pretensioned against a second friction part 80 on the component side in an axial direction 6 counter to the axial direction 8 by the spring element 68 mentioned above. The spring force 70 of the spring element 68, which—as is already the case in the embodiment variant of FIG. 3—in turn has a substantially annular form, interacts with oblique surfaces on the two friction parts 54, 78 on the actuating element side in such a way that they are pressed against the associated friction parts 56, 80 on the component side in mutually opposite axial directions 8, 6. As the rotational speed of the first running ring 44 or of the actuating element 42 together with the friction parts 54, 78 on the actuating element side increases, the spring element 68 is also elastically expanded under the action of centrifugal force, with the result that its spring force 70 and consequently the pretensioning force 72 is reduced, in order to automatically reduce the frictional force of the friction device 52.

FIG. 8 shows the schematic illustration of a drivetrain 82 for a motor vehicle having at least one embodiment of the freewheel arrangement 4 according to the invention. The drivetrain 82 has a first wheel axle 84, which can be driven by an electric drive unit or/and a combustion engine 88 via a differential 86. Furthermore, the drivetrain 82 has a second wheel axle 90, which can be driven by an additional electric drive unit 92 via a freewheel arrangement 4 and a differential 94, in order to realize a four-wheel drive or all-wheel drive as required. Inside the drivetrain 82, the first running ring 44 of the freewheel arrangement 4 is rotationally fixedly connected to the output side of the additional electric drive unit 92, while the second running ring 46 is rotationally fixedly connected to the second wheel axle 90 via the differential 94. By virtue of the freewheel arrangement 4, at low speeds of the motor vehicle, an additional drive via the electric drive unit 92 or the second wheel axle 90 can be particularly reliably realized.

In the drivetrain 82, the freewheel arrangement 4 is arranged in the torque transmission path between the additional electric drive unit 92 and the differential 94, the differential 94 leading to the wheels 100, 102 via two axle shafts 96, 98, which form the second wheel axle 90. In an embodiment variant of the drivetrain 82 that is likewise indicated in FIG. 8, by contrast, a respective freewheel arrangement 4, 4 is arranged in the torque transmission path between the differential 94 and the associated wheel 100 or 102, while it is possible to dispense with the freewheel arrangement 4 between the electric drive unit 92 and the differential 94. In this embodiment variant, it is also possible for the differential 94 and—depending on the specific arrangement of the freewheel arrangements 4, 4—optionally also parts of the axle shafts 96, 98 to be decoupled during driving operation and be at a standstill, in order to improve the energy efficiency of the drivetrain 82.

### LIST OF REFERENCE DESIGNATIONS

2 Freewheel
4 Freewheel arrangement
6 Axial direction
8 Axial direction
10 Radial direction
12 Radial direction
14 Circumferential direction
16 Circumferential direction
18 Axis of rotation
20 Outer ring
22 Inner ring
24 Clamping gap
26 First clamping element
28 Second clamping element
30 Rotational drive contour
32 Rotational drive contour
34 First rotational direction
36 Toothing
38 Second rotational direction
40 Spring element
42 Actuating element
44 First running ring
46 Second running ring
48 Recess
50 Actuating contour
52 Friction device
54 Friction part on the actuating element side
56 Friction part on the component side
58 Further component
60 Axial finger
62 Recesses
64 Side wall
66 Support element
68 Spring element
70 Spring force
72 Pretensioning force
74 Stop
76 Holding finger
78 Second friction part on the actuating element side
80 Second friction part on the component side
82 Drivetrain
84 First wheel axle
86 Differential
88 Electric drive unit or/and combustion engine
90 Second wheel axle
92 Additional electric drive unit
94 Differential
96 Axle shaft
98 Axle shaft
100 Wheel
102 Wheel
α Angular range

What is claimed is:

1. A freewheel arrangement having a freewheel, which comprises a first running ring, a second running ring, at least one clamping element that is between the first and the second running rings and is movable between a coupling position and a release position, and an actuating element for adjusting the at least one clamping element, the adjusting element being arranged on the first running ring and movable relative to the first running ring, wherein a friction device for generating a frictional force acting on the actuating element is provided, the frictional force counteracting a drive force acting on the first running ring so as to move the actuating element relative to the first running ring.

2. The freewheel arrangement as claimed in claim 1, wherein the friction device is configured such that, by increasing the rotational speed of the first running ring, the frictional force is automatically reduced.

3. The freewheel arrangement as claimed in claim 1, wherein the friction device comprises at least one friction part on the actuating element side, and at least one friction part on the component side that is configured to be brought into frictional engagement with the friction part on the actuating element side to obtain the frictional force.

4. The freewheel arrangement as claimed in claim 3, wherein the friction part on the actuating element side is pretensioned against the friction part on the component side by a spring element in a first axial direction, and a spring force, which is applicable to the friction part on the actuating element side by the spring element, is reduced, and the spring element interacts with the friction part on the actuating element side.

5. The freewheel arrangement as claimed in claim 3, wherein the friction part on the actuating element side is an axial finger, which is pretensioned inward in a radial direction against the friction part on the component side and is configured to be elastically bent outward in a radial direction under the action of centrifugal force with a reduction in a pretensioning force acting on the friction part on the component side against which the bent axial finger can be supported outwardly in a radial direction.

6. The freewheel arrangement as claimed in claim 1, wherein a side wall for covering a clamping gap that receives the clamping element and/or for supporting the clamping element in an axial direction is arranged on the first running ring.

7. The freewheel arrangement as claimed in claim 1, wherein the actuating element is rotatable relative to the first running ring and/or has an annular form and/or is movable between two end positions in which the actuating element is supported on the first running ring.

8. The freewheel arrangement as claimed in claim 1, wherein at least one first clamping element and at least one second clamping element are provided, which are rotationally conjointly connected to the first or the second running ring and of which the first clamping element is pivotable between the release position, in which the first or the second running ring is rotatable relative to the second or the first running ring in a first rotational direction, and the coupling position, in which the first or the second running ring is rotationally conjointly coupled to the second or the first running ring via the first clamping element in the first rotational direction, and the second clamping element is pivotable between the release position, in which the first or the second running ring is rotatable relative to the second or the first running ring in a second rotational direction counter to the first rotational direction, and the coupling position, in which the first or the second running ring is rotationally conjointly coupled to the second or the first running ring via the second clamping element in the second rotational direction.

9. The freewheel arrangement as claimed in claim 1, wherein the first running ring is in the form of an outer ring, on which the at least one clamping element is arranged, or is in the form of an inner ring, while the second running ring is in the form of an outer ring, on which the at least one clamping element is arranged.

10. A drivetrain for a motor vehicle, having a first wheel axle, which is drivable by an electric drive unit and/or a combustion engine, and a second wheel axle, wherein the second wheel axle and/or a wheel on the second wheel axle is selectively drivable by an additional electric drive unit via a freewheel arrangement as claimed in claim 1.

11. The drivetrain as claimed in claim 10, wherein the first running ring is rotationally fixedly connected to the additional electric drive unit and the second running ring is rotationally fixedly connected to the second wheel axle or to the wheel.

12. The freewheel arrangement as claimed in claim 3, wherein the at least one friction part on the actuating element side is rotationally conjointly coupled to the actuating element as a separate friction part or is formed in one piece with the actuating element, and the at least one friction part on the component side is fastened to a stationary component of the freewheel arrangement as a separate friction part or is formed in one piece with the stationary component.

13. The freewheel arrangement as claimed in claim 4, wherein the friction part on the actuating element side is pretensioned against the friction part on the component side by a second friction part on the actuating element side, which is pretensioned against a second friction part on the component side by the spring element in a second axial direction counter to the first axial direction.

14. The freewheel arrangement as claimed in claim 4, wherein the spring element is configured as a ring which can expand.

15. The freewheel arrangement as claimed in 6, wherein the actuating element is arranged between the first running ring and the side wall in an axial direction, and the axial finger extends through a recess in the sidewall.

16. The freewheel arrangement as claimed in 8, wherein the first clamping element assumes the release position and the second clamping element assumes the coupling position in a first end position of the actuating element, and the first clamping element assumes the coupling position and the second clamping element assumes the release position in a second end position of the actuating element, and both the first clamping element and the second clamping elements assume the release position in an intermediate position between the two end positions.
